(19) United States
(12) Patent Application Publication
(10) Pub. No.: US 2007/0290046 A1
(43) Pub. Date: Dec. 20, 2007

(54) Functional number locator and number modifier system

(76) Inventor: Joseph C. Pastrana, Methuen, MA (US)

Correspondence Address: JOSEPH C. PASTRANA, 27 QUINCY STREET, METHUEN, MA, 01844, US

(21) Appl. No.: 11/455,386

(22) Filed: Jun. 19, 2006

(51) Int. Cl. G06K 19/00

(52) U.S. Cl. 235/487

(57) ABSTRACT

This invention is a safeguard mechanism that protects a person from unauthorized examination of his/her account or identification number displayed on cards and documents. When the invention is utilized, the number displayed on the card or document is created by a cryptogram system. Hence, the embossed or imprinted numeric array displayed on the card or document is not representing a logical or functional number. However, the invention allows the cardholder to easily decode the numeric array displayed on the card, and read the correct account or identification number. Moreover, the invention allows the user to modify the account or identification number with alphabetical characters and link these characters to the period when the card is utilized. Thus, the card or document can only be used if the person assigns the correct alphabetical character for the particular time segment.

### CROSS-REFERENCE TO RELATED APPLICATIONS

Not Applicable

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

A common concern for any organization as well as for people is the security of their private or proprietary information. This issue becomes a major concern when the information must be shared with another organization or persons during the process of doing business or when the document gets lost or stolen. This invention addresses security issues related to private information imprinted or embossed on documents or cards issued for financial, medical, military, governmental, or commercial purposes. In particular, the purpose of the invention is to protect the account or identification number displayed on these types of cards or documents from unauthorized examination, reproduction or use.

### BRIEF SUMMARY OF THE INVENTION

When the invention is employed, the numeric array embossed or imprinted on a card or document (whether financial, medical, military, commercial, personal or governmental) will not represent a useful number, nor will it represent the account or identification number of the customer or user. For a person to uncover and reveal the correct number, he or she will need a set of numbers (two-digit number) to find out where the functional number that represents the account or identification number is located within the entire numeric array displayed in the document or card.

This two-digit number guides the user to the physical location of the first digit of the true numeric representation within the entire numeric array. The invention performs this task by first creating the account or identification number out of sequence, thus establishing and displaying a different numeric array. Second, it divides the entire numeric array into groups. Third, assigns a numeric representation to each group. Finally, numbers within every group are represented by another numeric representation. For example, if the first digit of the account number is located within the second group of numbers and in the third position of the digits representing this group, then the location of the first digit of the account or identification number is at 23. Thus, the number two represents the group and the number three represents the location of the first digit of the account or identification number.

Once the user locates the first digit, he or she can proceed to read the rest of the numeric or alphanumeric representation of the identification or account number. Thus, the object of the invention is to scramble the functional number within a displayed numeric array to avoid unauthorized access and maintain the privacy of the user.

### BRIEF DESCRIPTION OF THE SEVERAL VIEWS OF THE DRAWINGS

Not Applicable

### DETAILED DESCRIPTION OF THE INVENTION

The information on this section of the document addresses two schemes of this invention (with or without alphabetical characters). However, these examples are not to be construed as the only two means of how this invention works. There are too many variations that can be designed out of this principle or process. Thus, the inventor is not limiting his invention to these two examples; rather, he is using them for the purpose of explaining the invention and how it works. Furthermore, this section of the specification will use only Credit Cards as an example to portray what is being patented in this patent application as well as for simplicity purposes.

When the invention is employed on credit cards, the numeric array embossed or imprinted on the card does not represent a useful number, nor it represents the account number of the customer. A cryptogram program run by a computer system created the number displayed on the card. For a person to uncover and reveal the correct number, he or she will need a two-digit number (other set ups are possible), which is provided by the organization that issued the card. This two-digit number is also created by a computer system and it represents the location of the first digit of the account number displayed on the card. To create this link between the card number and the two-digit number, a database must be developed with the appropriate software.

In addition, the institution could issue two numbers and one or more alphabetical characters if replacement of numbers are to be utilized in the scheme. The introduction of alphabetical characters increases the number of combinations possible and the capability of relating and constraining the use of the card to a time period. The time period constrain feature is realized when the computer system and its program verifies that the user utilizes the correct assigned alphabetical character at the time when the card is used. For example, the user can be required to replace the first digit of his/her account number with the letter “H” when buying between the months of November and December. Thus, another security feature of the invention.

Regardless of the scheme chosen, the two-digit number exposes the first digit of the account or identification number. This two-digit number acts as the locator of the first digit of the account number and allows the customer to read the remainder of the number. The account number itself is set up in sequence and it is located within the numeric array displayed on the card.

The invention works by setting up the numeric array in sets or groups instead of one long continuous number. This arrangement is already in use in credit cards and it is currently done by the banking industry to make the reading of this long account number easier.

Credit cards display the embossed/imprinted sixteen-digits (16) account number in front of the card where the sixteen numbers are divided into four (4) groups of four (4) digits per group. However, the invention will have the displayed account number encrypted on the credit card. To read the correct account number, the customer utilizes the two-digit number to locate the first number of his/her account.

The two-digit code works as follows: the first digit identifies one of the four groups that compose the sixteen digit numerical array. This first digit will have a value from 1 to 4. Hence, if the first digit is the number two (2), then the location of the first number of the account is located within the second group of numbers.

The second digit locates the exact position of the first number of the account within the group of numbers. As with the first digit, the second digit will have a value from 1 to 4. Thus, if the second digit is represented by the number four (4), then that is where the position of the first number of the account is located. Once this process of identifying the first number of the account is done, the entire number can be read correctly. Accordingly, if the numeric array is composed of sixteen numbers, and the user starts reading from the 8^{th} position of the numeric array and from left to right in sequence, then the user must keep reading the remainder of the numeric array from the beginning of the displayed numeric array until all sixteen numbers are read.

However, there is a possibility that the first of the sixteen number displayed in the credit card could represent the first number of the customer's account number. But if alphabetical characters are required to replace the first digit, there is only one in four hundred and sixteen chances (1 in 416) that the first digit with its correct alphabetical character is correctly guessed.

As an illustration of the invention, consider the user that possess a card where the displayed array number on the card reads 3452-2709-7694-6921 and the assigned two-digit locator number is 24. The first digit of the locator number (#2) is identifying the second group out of the four groups of numbers that composes the numeric array. Thus, the number 2 signifies the position of the group (2^{nd}) within the groups displayed on the card or the second group from left to right.

The second digit (#4) of the two-digit locator is identifying the exact location of the first digit of the user's account number. This is the number 9 of the second group. Thus, the sixteen digits of his/her account number starts with the number nine (9) and the account number is 9769-4692-1345-2270 as read from left to right. If the system was designed to replace the first digit of the account number with the letter “K”, then the account number will read K769-4692-1345-2270.

The logical and functional account or identification number (which is encrypted in front of the card) could also be located on the magnetic strip or band of the card. This set up could permit a person to identify himself or herself as the person authorized to use the card by verifying and comparing the information read and displayed on a computerized system with information provided by the cardholder. For example, the computerized system at a store could read the magnetic strip, displaying it on a computer screen the correct numbering sequence to the store clerk, allowing the clerk to request the cardholder to identify the last four digits of his/her account number. The clerk can then verify the information given by the cardholder with the information displayed on the computer screen. The assumption is that the cardholder knows his/her account's last four digit numbers and can provide it to the clerk.

Thus, the purpose of the invention is to protect the customer from unauthorized examination, reproduction, or use of his/her account or identification number by creating a system that encrypts numeric logical representations displayed on cards.

### SEQUENCE OF LISTING

Not Applicable

What I claim as my invention is:

1. A cryptogram system that uses alphabetical, numerical or alphanumeric representations to create coded accounts or identification numbers displayed on cards or documents and the two-digit method to decode such cryptogram.

2. A cryptogram system where the numeric array is modified periodically with alphabetical characters to constrain the usefulness of the card to a time segment or period.

3. A cryptogram system that identifies the cardholder as the authorized person when the cardholder correctly provides an approved set of numeric or alphabetical characters taken from the encrypted numeric array displayed on the card or document.
